(19) United States
(12) Patent Application Publication
(10) Pub. No.: US 2026/0098201 A1
(43) Pub. Date: Apr. 9, 2026

(54) EXTENDED RELEASE SCALE INHIBITORS CONTAINING AMINE FUNCTIONALIZED SILICA

(71) Applicant: CHAMPIONX LLC, Sugar Land, TX (US)

(72) Inventors: Kaustubh RANE, Pearland, TX (US); Jesus CANTU, Pearland, TX (US); Bradley NGUYEN, Sugar Land, TX (US); Daniel DE VERA, Sugar Land, TX (US); Rangana JAYAWICKRAMAGE, Houston, TX (US); Julie FIDOE, Sugar Land, TX (US); Austen FLATT, Sugar Land, TX (US)

(73) Assignee: CHAMPIONX LLC, Sugar Land, TX (US)

(21) Appl. No.: 19/354,402

(22) Filed: Oct. 9, 2025

Related U.S. Application Data
(60) Provisional application No. 63/705,275, filed on Oct. 9, 2024.

(51) Int. Cl. C09K 8/528; E21B 41/02

(52) U.S. Cl. CPC C09K 8/528; E21B 41/02; C09K 2208/10

(57) ABSTRACT

A nanoparticle-well treatment additive complex comprising an amine functionalized silica nanoparticle, and a well treatment additive, where the well treatment additive is releasably attached to an amine group of the amine functionalized silica nanoparticle is disclosed. Methods of using the amine functionalized silica nanoparticle is also disclosed.

### CROSS REFERENCE TO RELATED APPLICATIONS

This application claims the benefit of and priority to U.S. Provisional Patent Application No. 63/705,275, filed Oct. 9, 2024. The contents of the referenced application are incorporated into the present application by reference.

### BACKGROUND OF THE INVENTION

### A. Field of the Invention

The invention generally concerns a nanoparticle composition containing a well treatment additive and methods of using the composition. In one aspect, the invention concerns a nanoparticle-well treatment additive complex comprising an amine functionalized silica nanoparticle and a well treatment additive, where the well treatment additive is releasably attached to an amine group of the amine functionalized silica nanoparticle. The nanoparticle-well treatment additive complex is suitable for treating subterranean wells that may have relatively high salinity, high calcium concentration, and/or high temperature, or any combination thereof.

### B. Description of Related Art

In oil wells scales are formed due to deposition of various minerals on the surface of the equipment used in the wells. If left untreated, the scaling can damage equipment and limit production to the extent it might eventually lead to shutdown of the well.

Typically, oil wells are treated with well treatment additives, such as scale inhibitors to prevent scale formation in the wells. However, many oil field wells harbor relatively harsh conditions such as high salinity, high calcium concentration, and/or high temperature. Treating those wells can become difficult and cost-inefficient with the currently commercially available scale inhibitors (e.g., (Hydroxyethylamino-Di(Methylene Phosphonic Acid) (HEMPA)), which are generally not compatible under these conditions. The current scale inhibitors such as HEMPA may also show relatively short squeeze life times. Short squeeze life time can lead to an increase in frequency in squeezing, which in turn can lead to production decrease and lower economic efficiency of operating the well.

### SUMMARY OF THE INVENTION

A discovery has been made that provides a solution to at least one or more of the aforementioned problems associated with well treatment additives. In one aspect, it has been discovered that a nanoparticle-well treatment additive complex containing an amine functionalized silica nanoparticle and a well treatment additive (e.g., HEMPA), where the well treatment additive is releasably attached to an amine group of the amine functionalized silica nanoparticle, is compatible in harsh conditions such as in solutions having relatively high salinity, calcium concentration, and/or temperature, or combination thereof. The nanoparticle-well treatment additive complexes of the present invention can have relatively high squeeze life time at such harsh conditions and can be used to treat oil wells harboring such conditions. In certain aspects, it was found that the squeeze life time of the nanoparticle-well treatment additive complex (e.g., amine functionalized silica nanoparticle-HEMPA complex) can be at least 2 times greater than the squeeze life time of a corresponding well treatment additive (e.g., HEMPA) that is not attached to such a nanoparticle. Without wishing to be bound by theory, it is believed that the nanoparticles can increase the squeeze life time of the well treatment additive by slowing the diffusion of the well treatment additive in one or more fluids used in the oil wells.

Some aspects of the disclosure are directed to a nanoparticle-well treatment additive complex containing an amine functionalized silica nanoparticle, and a well treatment additive, where the well treatment additive is releasably attached to the amine functionalized silica nanoparticle. In some embodiments, the well treatment additive is releasably attached to an amine group of the amine functionalized silica nanoparticle. The well treatment additive can be releasably attached to the amine group through an ionic bond, covalent bond, hydrogen bond, Van der Walls interaction, or by adsorption. In some aspects, the well treatment additive is directly attached to the amine group(s) of the amine functionalized silica nanoparticle without a bridging compound or agent positioned between the well treatment additive and the amine group(s). In some aspects, the bridging compound or agent can be a column 2, column 14, and/or transition metal (e.g., the metals described in US 2022/0145162).

In certain embodiments, the nanoparticle-well treatment additive complex has the chemical formula of Formula I:

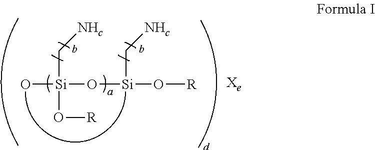

where X is the well treatment additive; a is an integer 3 to 20; b is an integer 1 to 10; c is set to balance charge and stoichiometry; and the ratio dee is 1:1 to 1:10. In certain embodiments, R is a C₁-C₁₀ alkyl. In certain embodiments, R is an ethyl group. In certain embodiments, R is a propyl group. In certain embodiments, a is 3 to 7. In certain embodiments, b is 2 to 5. In certain embodiments, the ratio die is 1:1 to 1:10. In certain embodiments, the ratio die is 1:1 to 1:5. In certain embodiments, R is an ethyl or propyl group; a is 3 to 7; b is 2 to 5; and die is 1:1 to 1:5. In certain particular embodiments, R is an ethyl group, a is 5, b is 3, and die is 1:2. In certain embodiments, the nanoparticle-well treatment additive complex has a particle size of 1 to 1000 nm, preferably 100 to 500 nm, more preferably 200 to 500 nm.

The well treatment additive can be a scale inhibitor, hydrate inhibitor, clay stabilizer, bactericide, salt substitute, relative permeability modifier, sulfide scavenger, corrosion inhibitor, corrosion inhibitor intensifier, pH control additive, surfactant, breaker, fluid loss control additive, asphaltene inhibitor, paraffin inhibitor, chelating agent, foamer, defoamer, emulsifier, a demulsifier, iron control agent, solvent, friction reducer, or any combination thereof.

In certain particular embodiments, the well treatment additive is a scale inhibitor. The scale inhibitor can contain a carboxylic acid functionality, a polycarboxylic acid functionality, aspartic acid functionality, maleic acid functionality, sulfonic acid functionality, phosphoric acid functionality, phosphonic acid functionality, phosphate ester group, salts thereof, or any combination thereof. In certain embodiments, the scale inhibitor contains a phosphoric acid functionality, phosphonic acid functionality, phosphate ester group, salts thereof, or any combination thereof. In certain embodiments, the scale inhibitor contains a phosphoric acid functionality, or salts thereof. In certain embodiments, the scale inhibitor contains a phosphonic acid functionality, or salts thereof. In certain embodiments, the scale inhibitor contains a phosphate ester group, or salts thereof. In certain embodiments, the phosphonic acid functionality is diethylenetriamine penta(methylene phosphonic acid) (DTPMPA), bis(hexamethylenetriaminepenta(methylenephosphonic acid)) (BHMTPMP), ethylene diamine tetra(methylene phosphonic acid) (EDTMPA), amino trimethylene phosphonic acid (ATMP), polyamino polyether methylene phosphonic acid (PAPEMP), hydroxyethylamino-di(methylene phosphonic acid) (HEMPA), 1-hydroxy ethylidene-1,1-diphosphonic acid (HEDP), 2-phosphonobutane-1,2,4-tricarboxylic acid (PBTC), 2-hydroxy phosphonoacetic acid (HPAA), or any combination thereof. In certain embodiments, the scale inhibitor contains DTPMPA or HEMPA, or both. In certain particular embodiments, the scale inhibitor contains HEMPA.

The well treatment additive can be capable of being released from the amine functionalized silica nanoparticle in a controlled manner over an extended period of time. In certain embodiments, the well treatment additive is capable of being released from the amine functionalized silica nanoparticle in a controlled manner over at least for 100 days, at least for 200 days, at least for 300 days, at least for 400 days, at least for 500 days, at least for 1000 days, at least for 2000 days, at least for 500 days to 2500 days, or at least for 500 days to 2000 days, after application.

The nanoparticle-well treatment additive complex can have a squeeze lifetime greater than that of a corresponding well treatment additive that is not releasably attached to the amine functionalized silica. As a non-limiting example, the squeeze lifetime of a nanoparticle-well treatment additive complex containing releasably attached HEMPA to a amine functionalized silica nanoparticle can be greater than HEMPA that is not attached to the amine functionalized silica nanoparticle. In certain embodiments, the nanoparticle-well treatment additive complex can have a squeeze lifetime at least 2 times greater than that of a corresponding well treatment additive that is not releasably attached to the amine functionalized silica nanoparticle. The squeeze lifetime of the nanoparticle-well treatment additive complex, and the corresponding well treatment additive can be measured under similar condition. The squeeze lifetime can be measured using a method described in example 1. In certain embodiments, the minimum effective dosage of the nanoparticle-well treatment additive complex (e.g., amine functionalized silica nanoparticle-HEMPA complex) is lower than the minimum effective dosage of a corresponding well treatment additive (e.g., HEMPA) that is not attached to such a nanoparticle. The minimum effective dosage can be measured using a method as described in example 3.

The nanoparticle-well treatment additive complex can be compatible in a solution having a high salinity, and/or high calcium concentration. In certain embodiments, the nanoparticle-well treatment additive complex is compatible in a solution having a salinity greater than 150,000 ppm. In certain embodiments, the nanoparticle-well treatment additive complex is compatible in a solution having a calcium concentration greater than 25,000 ppm. In certain embodiments, the nanoparticle-well treatment additive complex is compatible in a solution having a salinity greater than 150,000 ppm, and calcium concentration greater than 25,000 ppm. The nanoparticle-well treatment additive complex can be compatible at high temperatures. In certain embodiments, the nanoparticle-well treatment additive complex is compatible in a solution having a temperature greater than 100° C. In certain embodiments, the nanoparticle-well treatment additive complex is compatible in a solution having a temperature greater than 100° C., and salinity greater than 150,000 ppm. In certain embodiments, the nanoparticle-well treatment additive complex is compatible in a solution having a temperature greater than 100° C., and calcium concentration greater than 25,000 ppm. In certain embodiments, the nanoparticle-well treatment additive complex is compatible in a solution having a temperature greater than 100° C., salinity greater than 150,000 ppm, and calcium concentration greater than 25,000 ppm. The compatibility of the amine functionalized silica nanoparticle in a solution can be measured according to the protocol A described in example 2.

In certain embodiments, the amine functionalized silica nanoparticle and the well treatment additive is not complexed via a group 2, group 14, or a transition metal. In certain embodiments, the amine functionalized silica nanoparticle and the well treatment additive is not complexed via calcium.

Certain aspects of the disclosure are directed to an amine functionalized silica nanoparticle having the chemical formula of Formula II

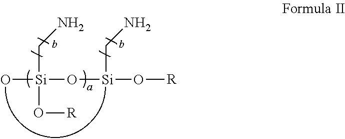

wherein a, b and R can be as defined above for Formula I.

Certain aspects of the disclosure are directed to a well treatment composition containing a nanoparticle-well treatment additive complex described herein. The well treatment composition can be a fluid. In certain embodiments, the well treatment composition is a liquid. The well-treatment composition can be a controlled-release composition capable of releasing the well treatment additive over an extended period of time. In certain embodiments, the controlled-release composition is capable of releasing the well treatment additive over at least for 100 days, at least for 200 days, at least for 300 days, at least for 400 days, at least for 500 days, at least for 1000 days, at least for 2000 days, at least for 500 days to 2500 days, or at least for 500 days to 2000 days, after application.

In certain embodiments, the well treatment composition contains water, salt water, acidic aqueous solution, low sulfate seawater, aqueous sodium carbonate solution, surfactant, other flush fluid, or any combination thereof.

Certain aspects are directed to a method of treating subterranean well formation the method comprising injecting a nanoparticle-well treatment additive complex or a well treatment composition described herein, into the subterranean well formation. The treatment can be squeeze treating, continuous treating, or spear treating the subterranean well formation. In certain embodiments, the treatment includes squeeze treating. In certain embodiments, the well treatment additive is released from the nanoparticle-well treatment additive complex over an extended period of time. In certain embodiments, the well treatment additive is released from the nanoparticle-well treatment additive complex over at least for 100 days, at least for 200 days, at least for 300 days, at least for 400 days, at least for 500 days, at least for 1000 days, at least for 2000 days, at least for 500 days to 2500 days, or at least for 500 days to 2000 days, after application. In certain embodiments, the subterranean well formation has one or more fluids having a temperature greater than 100° C., salinity greater than 150,000 ppm, calcium concentration greater than 25,000 ppm, or any combination thereof.

Also disclosed in the context of the present invention are Aspects 1 to 26. Aspect 1 is a nanoparticle-well treatment additive complex comprising an amine functionalized silica nanoparticle and a well treatment additive, wherein the well treatment additive is releasably attached to an amine group of the amine functionalized silica nanoparticle. Aspect 2 is the nanoparticle-well treatment additive complex of aspect 1, wherein the well treatment additive is releasably attached to the amine group through an ionic bond, covalent bond, hydrogen bond, Van der Walls interaction, or by adsorption. Aspect 3 is the nanoparticle-well treatment additive complex of aspects 1 or 2, having a formula of:

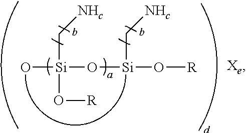

wherein X is the well treatment additive; R is H, alkyl, heteroalkyl, aryl, heteroaryl, alkenyl, or alkynyl group; a is an integer 3 to 20; b is an integer 1 to 10; c is set to balance charge and stoichiometry; and ratio de is 1:1 to 1:10. Aspect 4 is the nanoparticle-well treatment additive complex of aspect 3, wherein the alkyl group is ethyl or propyl. Aspect 5 is the nanoparticle-well treatment additive complex of aspects 3 or 4, wherein a is 3 to 7. Aspect 6 is the nanoparticle-well treatment additive complex of any one of aspects 3 to 5, wherein b is 2 to 5. Aspect 7 is the nanoparticle-well treatment additive complex of any one of aspects 3 to 6, wherein the ratio die is 1:1 to 1:10. Aspect 8 is the nanoparticle-well treatment additive complex of any one of aspects 3 to 7, wherein R is ethyl, a is 5, b is 3, and die is 1:2. Aspect 9 is the nanoparticle-well treatment additive complex of any one of aspects 1 to 8, having a particle size of 1 to 1000 nm, preferably 100 to 500 nm. Aspect 10 is the nanoparticle-well treatment additive complex of any one of aspects 1 to 9, wherein the well treatment additive is a scale inhibitor, hydrate inhibitor, clay stabilizer, bactericide, salt substitute, relative permeability modifier, sulfide scavenger, corrosion inhibitor, corrosion inhibitor intensifier, pH control additive, surfactant, breaker, fluid loss control additive, an asphaltene inhibitor, paraffin inhibitor, chelating agent, foamer, defoamer, emulsifier, demulsifier, iron control agent, solvent, friction reducer, or any combination thereof. Aspect 11 is the nanoparticle-well treatment additive complex of aspect 10, wherein the well treatment additive is a scale inhibitor. Aspect 12 is the nanoparticle-well treatment additive complex of aspect 11, wherein the scale inhibitor comprises a carboxylic acid functionality, polycarboxylic acid functionality, aspartic acid functionality, maleic acid functionality, sulfonic acid functionality, phosphoric acid functionality, phosphonic acid functionality, phosphate ester group, salts thereof, or any combination thereof. Aspect 13 is the nanoparticle-well treatment additive complex of aspect 12, wherein the phosphonic acid functionality is diethylenetriamine penta(methylene phosphonic acid) (DTPMPA), bis(hexamethylenetriaminepenta(methylenephosphonic acid)) (BHMTPMP), ethylene diamine tetra(methylene phosphonic acid) (EDTMPA), amino trimethylene phosphonic acid (ATMP), polyamino polyether methylene phosphonic acid (PAPEMP), hydroxyethylamino-di(methylene phosphonic acid) (HEMPA), 1-hydroxy cthylidene-1,1-diphosphonic acid (HEDP), 2-phosphonobutane-1,2,4-tricarboxylic acid (PBTC), 2-hydroxy phosphonoacetic acid (HPAA), or any combination thereof, preferably DTPMPA or HEMPA, or both. Aspect 14 is the nanoparticle-well treatment additive complex of aspect 12, wherein the scale inhibitor comprises HEMPA. Aspect 15 is the nanoparticle-well treatment additive complex of any one of aspects 1 to 14, wherein the well treatment additive is capable of being released from the nanoparticle in a controlled manner over an extended period of time such as at least for 100 days, at least for 200 days, at least for 300 days, at least for 400 days, at least for 500 days, at least for 1000 days, at least for 2000 days, at least for 500 days to 2500 days, or at least for 500 days to 2000 days after application. Aspect 16 is the nanoparticle-well treatment additive complex of any one of aspects 1 to 15, wherein a squeeze lifetime of the amine functionalized silica nanoparticle is greater than that of a corresponding well treatment additive that is not releasably attached to the amine functionalized silica nanoparticle. Aspect 17 is the nanoparticle-well treatment additive complex of any one of aspects 1 to 15, wherein a squeeze lifetime of the amine functionalized silica nanoparticle is at least 2 times greater than that of a corresponding well treatment additive that is not releasably attached to the amine functionalized silica nanoparticle. Aspect 18 is the nanoparticle-well treatment additive complex of any one of aspects 1 to 17, wherein the nanoparticle-well treatment additive complex is compatible i) at temperatures above 100° C. and/or ii) in solutions having salinity greater than 150,000 ppm and/or calcium concentration greater than 25000 ppm, wherein the compatibility is measured according to protocol A provided in example 2. Aspect 19 is the nanoparticle-well treatment additive complex of any one of aspects 1 to 18, wherein the amine functionalized silica nanoparticle is not complexed with a group 2, group 14, or a transition metal.

Aspect 20 is a well treatment composition comprising a nanoparticle-well treatment additive complex of any one of aspects 1 to 19. Aspect 21 is the well treatment composition of aspect 20, wherein the composition is a fluid. Aspect 22 is the well treatment composition of aspect 20 or 21, wherein the well-treatment composition is a controlled-release composition capable of releasing the well treatment additive over an extended period of time, such as at least for 100 days, at least for 200 days, at least for 300 days, at least for 400 days, at least for 500 days, at least for 1000 days, at least for 2000 days, at least for 500 days to 2500 days, or at least for 500 days to 2000 days after application. Aspect 23 is the well treatment composition of any one of aspects 20 to 23, further comprising water, salt water, acidic aqueous solution, low sulfate seawater, aqueous sodium carbonate solution, surfactant, or other flush fluid, or any combination thereof.

Aspect 24 is a method of treating a subterranean well formation, the method comprising injecting the nanoparticle-well treatment additive complex of any one of aspects 1 to 19, and/or the well treatment composition of any one of aspects 20 to 24 into the subterranean well formation. Aspect 25 is the method of aspects 25, wherein treating is squeeze treating, continuous treating, or spear treating the subterranean well formation. Aspect 26 is the method of aspect 25 or 26, wherein the well treatment additive is released from the nanoparticle-well treatment additive complex over an extended period of time.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The parts per million (ppm) concentrations recited in this disclosure are in parts per million by weight concentrations.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, which includes the component. In a non-limiting example, 10 grams of component in 100 grams of the material is 10 wt. % of component.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions of the present invention can “comprise,” “consist essentially of,” or “consist of” particular ingredients, components, compositions, etc. disclosed throughout the specification. With respect to the transitional phrase “consisting essentially of,” in one non-limiting aspect a basic and novel characteristic of the amine functionalized silica nanoparticles of the present invention are their ability to deliver a controllable release well treatment additive over an extended period of time during use (e.g., in subterrancan wells).

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of a method to treat a subterranean well formation using the nanoparticle-well treatment additive complex of the present invention.

### DETAILED DESCRIPTION OF THE INVENTION

A discovery has been made that provides a well treatment composition that is suitable for treating a subterranean well formation, e.g., a subterranean oil, gas well, water well, or any subterranean hydrocarbon reservoir, that may harbor harsh environments such as relatively high salinity, calcium concentration, and/or temperature, or any combination thereof. The well treatment composition can contain a nanoparticle-well treatment additive complex containing an amine functionalized silica nanoparticle and a well treatment additive, where the well treatment additive is releasably attached to an amine group of the amine functionalized silica nanoparticle. The well treatment additive (e.g., HEMPA) can be directly and releasably attached to the amine group(s) of the amine functionalized silica nanoparticle such that a bridging agent or compound (e.g., a metal or metal oxide) is not positioned between the amine functionalized silica nanoparticle and the well treatment additive. The nanoparticle-well treatment additive complex can be compatible in solutions having a relatively high salinity, high calcium concentration, and/or high temperature, or any combination thereof. The nanoparticle-well treatment additive complex can provide extended or sustained release of the well treatment additive even at such a harsh environment of use. Controlled release of such additives over an extended period of time decreases or eliminates the need to retreat the subterranean well formations with such additives, providing a cost and labor savings, and less environmental risks.

The invention provides an elegant way to provide a cost- and labor-effective methods to deliver subterranean treatment additives such as scale inhibitors to wells so that they release the additive over a long period of time, in a manner that reduces or eliminates the need to retreat wells with such complexed additives of the present invention or other non-complexed additives that have been previously used. The invention also provides effective methods to deliver the additives to fluids used to produce fluids (e.g., oil and gas) from subterranean formations. For example, delivery of additives to drilling fluid additives (mud additives), and/or enhanced oil recovery (EOR) fluids, or the like.

### A. Amine Functionalized Silica Nanoparticle With a Well Treatment Additive

The nanoparticle-well treatment additive complex of the present invention can contain an amine functionalized silica nanoparticles, and a well treatment additive. This combination can be referred to as a loaded amine functionalized silica nanoparticle or as a nanoparticle-well treatment additive complex. The well treatment additive can be releasable attached or bound or connected to the nanoparticle in a manner such that small, but effective, amounts of the additive is removed from the nanoparticles over a period of time.

The nanoparticle-well treatment additive complex can have a chemical formula of Formula I:

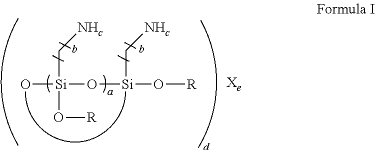

where X is the well treatment additive.

### 1. Amine Functionalized Silica Nanoparticle

In Formula I, a can be 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, or any integer range therebetween. In certain embodiments, a is an integer 3 to 50, 3 to 40, 3 to 30, 3 to 20, 3 to 10, 3 to 9, 3 to 8, 3 to 7, 3 to 6, 4 to 7, or 4 to 6. In certain embodiments, a is 3 to 7. In certain particular embodiments, a is 3. In certain particular embodiments, a is 4. In certain particular embodiments, a is 5. In certain particular embodiments, a is 6. In certain particular embodiments, a is 7.

In Formula I, b can 1, 2, 3, 4, 5, 6, 7, 8, 9, 10, 11, 12, 13, 14, 15, 16, 17, 18, 19, 20, 21, 22, 23, 24, or 25, or any integer range therebetween. In certain embodiments, b is an integer 1 to 25, 1 to 20, 1 to 15, 1 to 10, 1 to 8, 1 to 7, 1 to 5, or 2 to 5. In certain embodiments, b is 2 to 5. In certain particular embodiments, b is 1. In certain particular embodiments, b is 2. In certain particular embodiments, b is 3. In certain particular embodiments, b is 4. In certain particular embodiments, b is 5.

In Formula I, c is set to balance the charge and stoichiometry of the molecule.

In Formula I, R can be H, alkyl, heteroalkyl, aryl, heteroaryl, alkenyl, or alkynyl group. R can be branched or unbranched alkyl group. In certain embodiments, R is H. In certain embodiments, R is an alkyl group. In certain embodiments, R is a C₁-C₁₀ alkyl group. In certain embodiments, R is a methyl group. In certain embodiments, R is a ethyl group. In certain embodiments, R is a C₃ alkyl group. In certain embodiments, R is a n-propyl group. In certain embodiments, R is a iso-propyl group. In certain embodiments, R is a C₄ alkyl group. In certain embodiments, R is a n-butyl group. In certain embodiments, R is a iso-butyl group. In certain embodiments, R is a t-butyl group. In certain embodiments, R is a C₅ alkyl group. In certain embodiments, R is a C₆ alkyl group. In certain embodiments, R is a C₇ alkyl group. In certain embodiments, R is a C₈ alkyl group. In certain embodiments, R is a C₉ alkyl group. In certain embodiments, R is a C₁₀ alkyl group.

In Formula I, the ratio die can be 1:0, 1:0.5, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, or 1:25, or any range there between. In some embodiments, die is 1:0.5 to 1:25, 1:0.5 to 1:20, 1:1 to 1:20, 1:1 to 1:20, 1:1 to 1:15, 1:1 to 1:10, 1:1 to 1:8, or 1:1 to 1:5. In some particular embodiments, the ratio d:e is 1:1. In some particular embodiments, the ratio dee is 1:2. In some particular embodiments, the ratio die is 1:3. In some particular embodiments, the ratio die is 1:4. In some particular embodiments, the ratio dee is 1:5.

In certain embodiments, R is H, alkyl, heteroalkyl, aryl, heteroaryl, alkenyl, or alkynyl; a is an integer 3 to 20; b is an integer 1 to 10; the ratio dee is 1:1 to 1:10; and c is set to balance the charge and stoichiometry of the molecule. In certain embodiments, R is C₁-C₁₀ alkyl; a is an integer 3 to 7; b is an integer 2 to 5; die is 1:1 to 1:5; and c is set to balance the charge and stoichiometry of the molecule. In certain particular embodiments, R is ethyl; a is 5; b is 3; die is 1:3; and c is set to balance the charge and stoichiometry of the molecule.

In certain embodiments, the amine functionalized silica nanoparticle is not complexed with a group 2 metal. In certain embodiments, the amine functionalized silica nanoparticle is not complexed with calcium, such as Ca⁺². In certain embodiments, the amine functionalized silica nanoparticle is not complexed with a group 14 metal. In certain embodiments, the amine functionalized silica nanoparticle is not complexed with a transition metal.

Certain aspects are directed to the amine functionalized silica nanoparticle having the chemical formula of Formula II

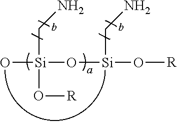

wherein a, b and R can be as defined for Formula I.

### 2. Well Treatment Additive

The well treatment additive can be connected via an amine group of the amine functionalized silica nanoparticle. In some embodiments, the well treatment additive is releasably attached to the amine group of the amine functionalized silica nanoparticle. The well treatment additive can be releasably attached to the amine group through an ionic bond, covalent bond, hydrogen bond, Van der Walls interaction, or by adhesion. The adhesion can be through absorption or adsorption onto the particle. The well treatment additive can be directly and releasably attached to the amine group(s) of the amine functionalized silica nanoparticle such that a bridging agent or compound (e.g., a metal or metal oxide) is not positioned between the amine functionalized silica nanoparticle and the well treatment additive.

The well treatment additive can be a scale inhibitor, hydrate inhibitor, clay stabilizer, bactericide, salt substitute, relative permeability modifier, sulfide scavenger, corrosion inhibitor, corrosion inhibitor intensifier, pH control additive, surfactant, breaker, fluid loss control additive, asphaltene inhibitor, paraffin inhibitor, chelating agent, foamer, defoamer, emulsifier, demulsifier, iron control agent, solvent, friction reducer, or any combination thereof. A scale inhibitor is a particularly preferred well treatment additive. The scale inhibitor can be a molecule, preferably an organic molecule, having a functionalized group. In certain embodiments, the functionalized group can bind to the nanoparticle. Non-limiting examples of functionalized groups include a carboxylic acid, a polycarboxylic acid, aspartic acid, maleic acid, sulfonic acid, phosphoric acid, phosphonic acid, a phosphate ester group, salts thereof, or any combination thereof. In certain embodiments, the scale inhibitor contains a phosphoric acid functionality, phosphonic acid functionality, a phosphate ester group, salts thereof, or any combination thereof. In certain embodiments, the scale inhibitor contains a phosphoric acid functionality, or salts thereof. In certain embodiments, the scale inhibitor contains a phosphonic acid functionality, or salts thereof. In certain embodiments, the scale inhibitor contains a phosphate ester group, or salts thereof. In certain embodiments, the phosphonic acid functionality is diethylenetriamine penta(methylene phosphonic acid) (DTPMPA), bis(hexamethylenetriaminepenta(methylenephosphonic acid)) (BHMTPMP), ethylene diamine tetra(methylene phosphonic acid) (EDTMPA), amino trimethylene phosphonic acid (ATMP), polyamino polyether methylene phosphonic acid (PAPEMP), hydroxyethylamino-di(methylene phosphonic acid) (HEMPA), 1-hydroxy ethylidene-1,1-diphosphonic acid (HEDP), 2-phosphonobutane-1,2,4-tricarboxylic acid (PBTC), 2-hydroxy phosphonoacetic acid (HPAA), or any combination thereof. In certain embodiments, the scale inhibitor contains DTPMPA or HEMPA, or both. In certain embodiments, the scale inhibitor contains HEMPA.

### B. Properties of the Nanoparticle-Well Treatment Additive Complex

The nanoparticle-well treatment additive complex can effect or inhibit performance of a material or fluid in a subterranean well, wellbore, hydrocarbon formation, reservoir, or the like. The well treatment additive can be released e.g., separated from the amine functionalized silica nanoparticles in response to a stimuli (e.g., formation fluid, water, or pressure).

The well treatment additive is capable of being released from the nanoparticle-well treatment additive complex in a controlled manner over an extended period of time. In certain embodiments, the well treatment additive is capable of being released from the nanoparticle-well treatment additive complex in a controlled manner over at least for 100 days, 200 days, 300 days, 400 days, 500 days, 1000 days, 1200 days, 1400 days, 1600 days, 1800 days, 2000 days, at least for 100 days to 2500 days, at least for 100 days to 2000 days, at least for 100 days to 1500 days, at least for 300 days to 2500 days, at least for 300 days to 2000 days, at least for 300 days to 1500 days, at least for 500 days to 2500 days, at least for 500 days to 2000 days, or at least for 500 days to 1500 days.

The nanoparticle-well treatment additive complex can have a particle size of 1 to 1000 nm; 10 to 900 nm; 50 to 800 nm; 100 nm to 700 nm; 150 nm to 600 nm, preferably 200 to 500 nm, or more preferably 100 to 500 nm. The particle size can be measured using dynamic light scattering (DLS) method.

The nanoparticle-well treatment additive complex can have a squeeze lifetime greater than that of a corresponding well treatment additive that is not releasably attached to the amine functionalized silica. For example, the corresponding well treatment additive of a nanoparticle-HEMPA complex is HEMPA that is not attached to the amine functionalized silica nanoparticle. As a non-limiting example, squeeze lifetime of an nanoparticle-well treatment additive complex containing releasably attached HEMPA can be greater than that of a HEMPA that is not attached to the amine functionalized silica nanoparticle. In certain embodiments, the nanoparticle-well treatment additive complex can have a squeeze lifetime at least 1.1 times greater, 1.2 times greater, 1.3 times greater, 1.4 times greater, 1.5 times greater, 1.6 times greater, 1.7 times greater, 1.8 times greater, 1.9 times greater, 2 times greater, 3 times greater, 4 times greater, 5 times greater, 1.1 to 10 times, 1.5 to 5 times, 1.5 to 4 times than that of a corresponding well treatment additive that is not releasably attached to the amine functionalized silica. In certain particular embodiments, the nanoparticle-well treatment additive complex can have a squeeze lifetime at least 2 times greater than that of a corresponding well treatment additive that is not releasably attached to the amine functionalized silica. The squeeze lifetime of the nanoparticle-well treatment additive complex and the corresponding well treatment additive can be measured under similar condition. The squeeze lifetime can be measured using the method described in example 1.

The nanoparticle-well treatment additive complex can be compatible in solutions having a high salinity and/or high calcium concentration. In certain embodiments, the nanoparticle-well treatment additive complex is compatible in solutions having a salinity greater than 70,000; 80,000; 90,000; 100,000; 110,000; 120,000; 130,000; 140,000; 150,000; 160,000; 170,000; 180,000; 190,000; 200,000; 210,000; 220,000; 230,000; 240,000; 250,000; 260,000; 270,000; 280,000; 290,000; or 300,000 ppm. In certain embodiments, the nanoparticle-well treatment additive complex is compatible in solutions having a salinity 70,000 to 300,000 ppm; 70,000 to 250,000 ppm; 70,000 to 200,000 ppm; 90,000 to 300,000 ppm; 90,000 to 250,000 ppm; 90,000 to 250,000 ppm; 100,000 to 300,000 ppm; 100,000 to 250,000 ppm; or 100,000 to 250,000 ppm. In certain particular embodiments, the nanoparticle-well treatment additive complex is compatible in solutions having a salinity greater than 150,000 ppm. In certain embodiments, the nanoparticle-well treatment additive complex is compatible in solutions having a calcium concentration greater than 15,000; 16,000; 18,000; 20,000; 22,000; 24,000; 26,000; 28,000; 29,000; 30,000; 32,000; 34,000; 36,000; 38,000; 40,000; 42,000; 44,000; 46,000; 48,000; or 50,000 ppm. In certain embodiments, the nanoparticle-well treatment additive complex is compatible in solutions having a calcium concentration 15,000 to 50,000 ppm; 15,000 to 45,000 ppm; 15,000 to 40,000 ppm; 15,000 to 35,000 ppm; 20,000 to 50,000 ppm; 20,000 to 45,000 ppm; 20,000 to 40,000 ppm; or 20,000 to 35,000 ppm. In certain embodiments, the nanoparticle-well treatment additive complex is compatible in solutions having a calcium concentration greater than 25,000 ppm. In certain embodiments, the nanoparticle-well treatment additive complex is compatible in solutions having a salinity greater than 150,000 ppm, and calcium concentration greater than 25,000 ppm. In certain embodiments, the nanoparticle-well treatment additive complex is compatible in solutions having a salinity greater than 200,000 ppm, and calcium concentration greater than 28,000 ppm. In certain particular embodiments, the nanoparticle-well treatment additive complex is compatible at a solution having a salinity 150,000 to 250,000 ppm and calcium concentration 25,000 to 30,000 ppm.

The nanoparticle-well treatment additive complex can be compatible at high temperatures. In certain embodiments, the nanoparticle-well treatment additive complex is compatible in solutions having a temperature greater than 90, 100, 110, 120, 130, 140, 150, 160, 170, 180, 190, 200, 220, or 250° C. In certain embodiments, the nanoparticle-well treatment additive complex is compatible in solutions having a temperature 90 to 300° C., 90 to 250° C., 90 to 200° C., 100 to 300° C., 100 to 250° C., 100 to 200° C., 150 to 300° C., 150 to 250° C., or 150 to 200° C. In certain embodiments, the nanoparticle-well treatment additive complex is compatible in solutions having a temperature above 100° C. and salinity greater than 150,000 ppm. In certain embodiments, the nanoparticle-well treatment additive complex is compatible in solutions having a temperature above 100° C. and calcium concentration greater than 25,000 ppm. In certain particular embodiments, the nanoparticle-well treatment additive complex is compatible in solutions having a temperature above 100° C., salinity greater than 150,000 ppm, and calcium concentration greater than 25,000 ppm. In certain particular embodiments, the nanoparticle-well treatment additive complex is compatible in solutions having a temperature above 150° C., salinity greater than 200,000 ppm, and calcium concentration greater than 28,000 ppm. In certain particular embodiments, the nanoparticle-well treatment additive complex is compatible in solutions having a temperature 150° C. to 200° C., salinity 150,000 to 250,000 ppm, and calcium concentration 25,000 to 30,000 ppm. The solutions as recited in this paragraph can be an aqueous solution. The compatibility of the nanoparticle-well treatment additive complex can be measured using the protocol A described in example 2.

In certain embodiments, the minimum effective dosage of the nanoparticle-well treatment additive complex (e.g., amine functionalized silica nanoparticle-HEMPA complex) is lower than the minimum effective dosage of a corresponding well treatment additive (e.g., HEMPA) that is not attached to such a nanoparticle. The minimum effective dosage can be measured using a method as described in example 3.

### C. Compositions Containing the Amine Functionalized Silica Nanoparticle-Well Treatment Additive Complex

One aspect of the disclosure is directed to a well treatment composition containing an nanoparticle-well treatment additive complex described herein. The nanoparticle-well treatment additive complex of the present disclosure can be provided to a treatment site as individual nanoparticle-well treatment additive complex or as the well treatment composition. In certain embodiments, the well treatment composition can include a fluid (e.g., an aqueous liquid) that contains a plurality of the nanoparticle-well treatment additive complexes (e.g., as a slurry). The composition can be a controlled-release composition capable of releasing the well treatment additive over an extended period of time. These compositions can be prepared by admixing the nanoparticle-well treatment additive complex described herein with a fluid that will be injected into the well.

The nanoparticle-well treatment additive complex content in the well treatment composition can be at least 10, 15, 20, 25, 30, 35, 40, 45, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95%. In certain embodiments, the well treatment composition contains water, salt water, acidic aqueous solution, low sulfate seawater, aqueous sodium carbonate solution, surfactant, other flush fluid, or any combination thereof.

### D. Methods of Treating Subterranean Well Formation or Wellbores

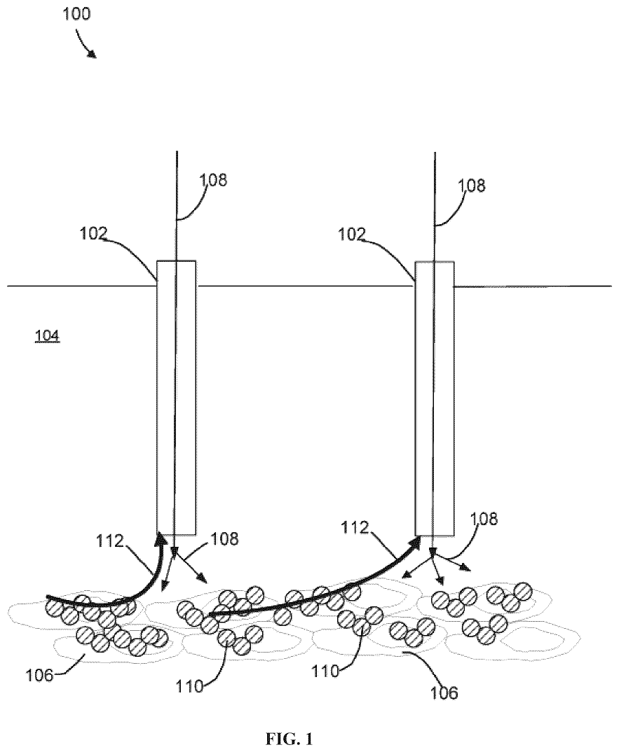

The nanoparticle-well treatment additive complexes or the well treatment compositions containing the same can be delivered to a subterranean well formation using a variety of methods including but not limited to pumping, pressure injection, or the like. In some embodiments, a squeeze or continuous treatment method is used. A method of treating a subterranean well formation is depicted in FIG. 1. In addition to treating wells, the nanoparticle-well treatment additive complexes or the well treatment compositions containing the same can be used to deliver additives to the subterranean well formation for other purposes (e.g., deliver mud additives to drilling fluids or enhanced oil recovery fluids, or the like). Wells 102 can intersect the subterranean formation, and can be injection wells, production wells, water wells, or the like. As shown, the wells 102 intersect as vertical wells, but can be horizontal wells. Wells 102 can be uncased wellbores, cased wellbores or the like. In method 100, prior to production from well 102, the nanoparticle-well treatment additive complexes or well treatment composition of the present invention can be injected into one or more wells 102, flow through the well and into subterranean formation 104 as shown by arrow 108. The nanoparticle-well treatment additive complexes 110 can be deposited on rock formation 106 in the subterranean formation. Any suitable equipment, such as drilling equipment (e.g., oil, gas, or water drilling equipment) can be used to inject the subterranean well treatment compositions into wells 102 (e.g., using a squeeze method, continuous method, or spear method). The nanoparticle-well treatment additive complexes can get adsorbed to the formation rock 106 and the well treatment additive loaded on the nanoparticle-well treatment additive complexes can be released to the well 102 in an amount effective to perform the necessary function (e.g., inhibit scale) when the well is put into production. As shown in the FIG. 1, fluid can flow over the rock as shown by arrow 112 and dissolve or desorb a small amount of the well treatment additive from the nanoparticle-well treatment additive complex. The formation fluid containing the well treatment additive can then flow into the well. The well treatment additive can coat or interact with the well materials or fluid in the well to treat the well (e.g., inhibit scale). By way of example, the well treatment additive can be a scale inhibitor and contact of the formation fluid with the scale inhibitor containing amine functionalized silica nanoparticles dissolves or desorbs an effective amount of the scale inhibitor from the nanoparticle-well treatment additive complex and carries the scale inhibitor into the well. The scale inhibitor can interact with the well material and/or fluids in the well to inhibit scale from forming on the inside portion of the wall of well 102. In certain embodiments, the formation fluid can have a relatively high temperature, high salinity, high calcium concentration, or any combination thereof. In certain embodiments, the formation fluid has a temperature greater than 100° C., salinity greater than 150,000 ppm, calcium concentration greater than 25,000 ppm, or any combination thereof. In certain embodiments, the formation fluid has a temperature greater than 150° C., salinity greater than 200,000 ppm, calcium concentration greater than 29,000 ppm, or any combination thereof. The interaction of the amine functionalized silica nanoparticle and adherence of the well treatment additive to the nanoparticle allows an effective amount of additive to be released from the nanoparticle over an extended period of time (e.g., greater than 5 years).

### EXAMPLES

The present invention will be described in greater detail by way of specific examples. The following examples are offered for illustrative purposes only and are not intended to limit the invention in any manner. Those of skill in the art will readily recognize a variety of noncritical parameters which can be changed or modified to yield essentially the same results.

### A. Example 1-Squeeze Lifetime Measurement of Experiment Using the (SiO(OCH₂CH₃)C₂H₄NH₂)₆/HEMPA and Comparative HEMPA

Squeeze lifetime for amine functionalized silica nanoparticles having the formula of (SiO(OCH₂CH₃)C₂H₄NH₂)₆/HEMPA, and for comparative HEMPA were measured using a core-flood method. In(SiO(OCH₂CH₃)C₂H₄NH₂)₆/HEMPA, HEMPA is releasably attached to an amine group of SiO(OCH₂CH₃)C₂H₄NH₂. The comparative HEMPA is not attached to SiO(OCH₂CH₃)C₂H₄NH₂. The experiments were performed to simulate the adsorption and desorption under well conditions having high salinity (>200,000 ppm), high calcium concentration (>29,000 ppm), and high temperature (>177° C.). Table 1 lists the squeeze recipe that was used. In one experiment (SiO(OCH₂CH₃)C₂H₄NH₂)₆/HEMPA was used as the scale inhibitor formulation, and in another experiment the comparative HEMPA was used as the scale inhibitor formulation.

TABLE 1
Squeeze recipe

Stage

| | |
|---|---|
| Preflush | Fresh water + mutual solvent + biocide + scale inhibitor formulation |
| Main Stage | Fresh water + scale inhibitor formulation + biocide |
| Overflush | Fresh water + scale inhibitor formulation + biocide |
| Shut in | 18 hours |

Back pressure was maintained at 1000 psi. The threshold HEMPA concentration minimum effective concentration (MEC) to stop the flowback was set as 5 ppm. During the experiment with (SiO(OCH₂CH₃)C₂H₄NH₂)₆/HEMPA no pressure build-up and no blocking in the crushed core or in the tubing were observed. Table 2 lists the number of pore volumes required to reached the MEC for different scale inhibitor formulations. As can be seen from Table 2, (SiO(OCH₂CH₃)C₂H₄NH₂)₆/HEMPA shows a pore volume and the life time of the product that is more than 200% compared to comparative HEMPA at pH 3.2.

TABLE 2
Pore volume of the scale inhibitor formulations.

| Product | Pore volume at HEMPA >5 ppm |
|---|---|
| (SiO(OCH₂CH₃)C₂H₄NH₂)₆/HEMPA X wt. % | 2000 |
| at pH 3 | |
| neat HEMPA X wt. % at pH 3.2 | 800 |

### B. Example 2: Compatibility of (SiO(OCH₂CH₃)C₂H₄NH₂)₆/HEMPA, Protocol A

### 1. Brine Compatibility

(SiO(OCH₂CH₃)C₂H₄NH₂)₆/HEMPA at squeeze concentration (10 wt. %) along with biocide and oxygen scavenger was mixed with synthetic brine solutions having different brine concentrations. The mixtures were kept at 177° C. for 24 hours and were then observed for precipitation/floaties/milkiness. (SiO(OCH₂CH₃)C₂H₄NH₂)₆/HEMPA was marked as compatible at a brine concentration when no precipitation/floaties/milkiness was observed after 24 hours at 177° C. Table 3 shows the brine concentrations that were used and results of the experiment. As can be seen from Table 3, (SiO(OCH₂CH₃)C₂H₄NH₂)₆/HEMPA is compatible at brine concentrations of at least up to 246,000 ppm.

TABLE 3
Brine compatibility of (SiO(OCH₂CH₃)C₂H₄NH₂)₆/HEMPA

| Brine | | |
|---|---|---|
| concentration | (SiO(OCH₂CH₃)C₂H₄NH₂)₆/HEMPA | |
| (vol. %) | concentration (vol. %) | precipitation/floaties/milkiness |
| 99 | 1 | No precipitation/floaties/milkiness |
| 90 | 10 | No precipitation/floaties/milkiness |
| 75 | 25 | No precipitation/floaties/milkiness |
| 50 | 50 | No precipitation/floaties/milkiness |
| 25 | 75 | No precipitation/floaties/milkiness |
| 10 | 90 | No precipitation/floaties/milkiness |
| 1 | 99 | No precipitation/floaties/milkiness |

### 2. Calcium Compatibility

(SiO(OCH₂CH₃)C₂H₄NH₂)₆/HEMPA at squeeze concentration (10 wt. %) was mixed with solutions having different calcium concentrations. The mixtures were kept at three different temperatures (85° C., 110° C., and 177° C.) for 24 hours and were then observed for precipitation/floaties/milkiness. (SiO(OCH₂CH₃)C₂H₄NH₂)₆/HEMPA was marked as compatible at a calcium concentration when no precipitation/floaties/milkiness was observed after 24 hours at all three temperatures. Table 4 shows the calcium concentrations that were used and results of the experiment. As can be seen from Table 4, (SiO(OCH₂CH₃)C₂H₄NH₂)₆/HEMPA is compatible at calcium concentrations at least up to 29,100 ppm

TABLE 4
Calcium solution compatibility of (SiO₂(CH₂CH₃)C₂H₄NH₂)₆/HEMPA

| Calcium | | |
|---|---|---|
| concentration | (SiO(OCH₂CH₃)C₂H₄NH₂)₆/HEMPA | |
| (ppm) | concentration (wt. %) | precipitation/floaties/milkiness |
| 10000 | 10 | No |
| | | precipitation/floaties/milkiness |
| 20000 | 10 | No |
| | | precipitation/floaties/milkiness |
| 29100 | 10 | No |
| | | precipitation/floaties/milkiness |

### 3. Thermal Stability/Compatibility

The (SiO(OCH₂CH₃)C₂H₄NH₂)₆/HEMPA complex was tested for thermal stability/compatibility as a neat product at 17° C. and 60° C. for 24 hours and 1 month. The formulation was stable for both the time periods and did not show any precipitation/floaties/milkiness. In addition, the (SiO(OCH₂CH₃)C₂H₄NH₂)₆/HEMPA complex was also tested for thermal stability at 149° C. for 24 hours. Again, the formulation was stable for the time periods and did not show any precipitation/floaties/milkiness.

### C. Example 3: Effect on Minimum Effective Dosage (MED)

(SiO(OCH₂CH₃)C₂H₄NH₂)₆/HEMPA and a comparative HEMPA incumbent were tested for the minimum effective dosage (MED) using a dynamic scale loop. The test was conducted at 165° C. and 2500 psi with synthetic brine of pH 6.6-6.8. For the test, equal flow rates of cationic and anionic brine were mixed in a 1 m length reaction coil with an inner diameter of 0.04 inches (1 mm) and the residence time for scaling was measured with and without scale inhibitor. Various concentrations comparative incumbent HEMPA and (SiO(OCH₂CH₃)C₂H₄NH₂)₆/HEMPA were tested, and it was determined that the comparative incumbent HEMPA demonstrated a MED of 10 ppm, whereas the (SiO(OCH₂CH₃)C₂H₄NH₂)₆/HEMPA reduced the MED by 25% to 7.5 ppm.

Although embodiments of the present application and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A nanoparticle-well treatment additive complex comprising an amine functionalized silica nanoparticle and a well treatment additive, wherein the well treatment additive is releasably attached to an amine group of the amine functionalized silica nanoparticle.

2. The nanoparticle-well treatment additive complex of claim 1, wherein the well treatment additive is releasably attached to the amine group through an ionic bond, covalent bond, hydrogen bond, Van der Walls interaction, or by adsorption.

3. The nanoparticle-well treatment additive complex of claim 2, having a formula of: 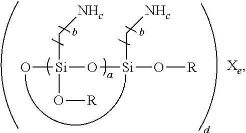
wherein X is the well treatment additive; R is H, alkyl, heteroalkyl, aryl, heteroaryl, alkenyl, or alkynyl group; a is an integer 3 to 20; b is an integer 1 to 10; c is set to balance charge and stoichiometry; and ratio de is 1:1 to 1:10.

4. The nanoparticle-well treatment additive complex of claim 3, wherein the alkyl group is ethyl or propyl.

5. The nanoparticle-well treatment additive complex of claim 4, wherein a is 3 to 7.

6. The nanoparticle-well treatment additive complex of claim 5, wherein b is 2 to 5.

7. The nanoparticle-well treatment additive complex of claim 6, wherein the ratio dee is 1:1 to 1:10.

8. The nanoparticle-well treatment additive complex of claim 7, wherein R is ethyl, a is 5, b is 3, and d:e is 1:2.

9. The nanoparticle-well treatment additive complex of any one of claim 1, having a particle size of 1 to 1000 nm.

10. The nanoparticle-well treatment additive complex of claim 1, wherein the well treatment additive is a scale inhibitor, hydrate inhibitor, clay stabilizer, bactericide, salt substitute, relative permeability modifier, sulfide scavenger, corrosion inhibitor, corrosion inhibitor intensifier, pH control additive, surfactant, breaker, fluid loss control additive, an asphaltene inhibitor, paraffin inhibitor, chelating agent, foamer, defoamer, emulsifier, demulsifier, iron control agent, solvent, friction reducer, or any combination thereof.

11. The nanoparticle-well treatment additive complex of claim 10, wherein the well treatment additive is a scale inhibitor.

12. The nanoparticle-well treatment additive complex of claim 11, wherein the scale inhibitor comprises HEMPA.

13. The nanoparticle-well treatment additive complex of claim 1, wherein the well treatment additive is capable of being released from the nanoparticle in a controlled manner for 500 days to 2000 days after application.

14. The nanoparticle-well treatment additive complex of claim 1, wherein a squeeze lifetime of the amine functionalized silica nanoparticle is greater than that of a corresponding well treatment additive that is not releasably attached to the amine functionalized silica nanoparticle.

15. The nanoparticle-well treatment additive complex of claim 1, wherein the nanoparticle-well treatment additive complex is compatible i) at temperatures above 100° C. and ii) in solutions having salinity greater than 150,000 ppm and/or calcium concentration greater than 25000 ppm, wherein the compatibility is measured according to protocol A provided in example 2.

16. The nanoparticle-well treatment additive complex of claim 1, wherein the amine functionalized silica nanoparticle is not complexed with a group 2, group 14, or a transition metal.

17. A well treatment composition comprising a nanoparticle-well treatment additive complex of claim 1.

18. The well treatment composition of claim 17, wherein the composition is a fluid.

19. A method of treating a subterranean well formation, the method comprising injecting the nanoparticle-well treatment additive complex of claim 1 into the subterranean well formation.

20. The method of claim 19, wherein treating is squeeze treating, continuous treating, or spear treating the subterranean well formation.
